(19) United States
(12) Patent Application Publication
(10) Pub. No.: US 2025/0077922 A1
(43) Pub. Date: Mar. 6, 2025

(54) MAPPING METHOD FOR A QUANTUM PROGRAM AND A QUANTUM CHIP, QUANTUM COMPUTER OPERATING SYSTEM AND COMPUTER

(71) Applicant: Origin Quantum Computing Technology (Hefei) Co. Ltd., Hefei, Anhui (CN)

(72) Inventors: Menghan Dou, Anhui (CN); Dongyi Zhao, Anhui (CN); Yuan Fang, Anhui (CN); Wentao Wang, Anhui (CN); Jing Wang, Anhui (CN)

(73) Assignee: Origin Quantum Computing Technology (Hefei) Co. Ltd., Hefei, Anhui (CN)

(21) Appl. No.: 18/580,464

(22) PCT Filed: Aug. 16, 2022
(86) PCT No.: PCT/CN2022/112765

§ 371 Date: Jan. 18, 2024

(30) Foreign Application Priority Data
Aug. 17, 2021 (CN) 202110941255.8
Aug. 17, 2021 (CN) 202110941261.3

(51) Int. Cl. G06N 10/20; G06N 10/80

(52) U.S. Cl. CPC G06N 10/20; G06N 10/80

(57) ABSTRACT

Disclosed are a mapping method for a quantum program and a quantum chip, a quantum computer, and a computer. The method comprises: obtaining topological structures of physical bits in a quantum chip, a logic gate set of an initial quantum program, and an initial mapping relationship between logic bits and the physical bits; determining an execution timing of the logic gate set of the initial quantum program bits; according to the topological structures of physical bits and the initial mapping relationship, adjusting the mapping relationships between the logic bits and the physical bits corresponding to each logic gate so as to obtain the final mapping relationship; and according to the final mapping relationship, constructing the to-be-mapped quantum program equivalent to the initial quantum program to minimize the number of SWAP quantum logic gates in the to-be-mapped quantum program.

### CROSS-REFERENCES TO RELATED APPLICATIONS

The disclosure is a National Stage of International Application No. PCT/CN2022/112765, filed on Aug. 16, 2022, which claims priority to a Chinese patent application No. CN 202110941255.8 filed on Aug. 17, 2021 and entitled “METHOD AND DEVICE FOR DETERMINING TARGET MAPPING OF THE QUANTUM PROGRAM TO BE EXECUTED AND QUANTUM COMPUTER” and to a Chinese patent application No. CN 202110941261.3 filed on Aug. 17, 2021 and entitled “METHOD AND DEVICE FOR CONSTRUCTING TO-BE-MAPPED QUANTUM PROGRAM AND QUANTUM COMPUTER”, which are hereby incorporated by reference in their entireties.

### TECHNICAL FIELD

The present disclosure relates to the field of quantum program compilation, particularly to a mapping method for a quantum program and a quantum chip, a mapping device for a quantum program and a quantum chip, a storage medium, an electronic device, a quantum computer operating system and a quantum computer.

### BACKGROUND

Quantum computers are a class of physical devices that follow the laws of quantum mechanics to perform high-speed mathematical and logical operations, store and process quantum information. A device is a quantum computer when it processes and computes quantum information and runs quantum algorithms. Quantum computers become a key technology being researched because of their ability to handle mathematical problems more efficiently than ordinary computers, for example, to accelerate time cost for cracking RSA keys from hundreds of years to a few hours.

In the Noisy Intermediate-Scale Quantum phase, each quantum chip has its own topological structure, which reflects the connections between the qubits of the quantum chip. In practical quantum programming, after obtaining the logic gate set of the quantum program and the initial mapping of logic-physical bits, a double-qubit logic gate act on any two qubits may be limited by the chip structure, and the double-bit logic gate cannot be implemented on quantum. Therefore, it is necessary to exchange and convert any double-qubit logic gate until it is converted into the quantum logic gate supportable to the chip, otherwise the utilization of the computing resource of the quantum chip cannot be improved.

### SUMMARY

An objective of the present disclosure is to provide a mapping scheme for a quantum program and a quantum chip, so as to improve the resource utilization of the entire quantum chip.

One embodiment of the present disclosure provides a mapping method for a quantum program and a quantum chip, which comprises: obtaining topological structures of physical bits in a quantum chip, a logic gate set of an initial quantum program, and an initial mapping relationship between logic bits and the physical bits; determining an execution timing of the logic gate set of the initial quantum program; according to the topological structures of the physical bits and the initial mapping relationship, adjusting a mapping relationship between a logic bit corresponding to each logic gate and a physical bit in accordance with the execution timing, thus obtaining a final mapping relationship; constructing a to-be-mapped quantum program equivalent to the initial quantum program according to the final mapping relationship, so as to minimize a quantity of SWAP quantum logic gates in the to-be-mapped quantum program.

Another embodiment of the present disclosure provides a mapping device for a quantum program and a quantum chip, which comprises: an obtaining module configured for obtaining topological structures of physical bits in a quantum chip, a logic gate set of an initial quantum program, and an initial mapping relationship between logic bits and the physical bits; a determining module configured for determining an execution timing of the logic gate set of the initial quantum program; an adjusting module configured for, according to the topological structures of the physical bits and the initial mapping relationship, adjusting a mapping relationship between a logic bit corresponding to each logic gate and a physical bit in accordance with the execution timing, thus obtaining a final mapping relationship; a constructing module configured for constructing a to-be-mapped quantum program equivalent to the initial quantum program according to the final mapping relationship, so as to minimize a quantity of SWAP quantum logic gates in the to-be-mapped quantum program.

Another embodiment of the present disclosure provides a mapping method for a quantum program and a quantum chip, which comprises: obtaining a directed acyclic graph of a to-be-executed quantum program and an initial mapping relationship between logic bits and the physical bits; according to the directed acyclic graph of the to-be-executed quantum program, determining an execution timing of a to-be-mapped logic gate set of the to-be-executed quantum program; separately determining cost of mapping each logic gate in the to-be-mapped logic gate set to the topological structures of the quantum chip according to the execution timing and the initial mapping relationship; according to the cost of mapping each logic gate to the topological structures of the quantum chip, adjusting the target mapping of the to-be-executed quantum program to minimize cost of the target mapping.

Another embodiment of the present disclosure provides a mapping device for a quantum program and a quantum chip, which comprises: an obtaining module configured for obtaining a directed acyclic graph of a to-be-executed quantum program and an initial mapping relationship between logic bits and the physical bits; a first determining module configured for, according to the directed acyclic graph of the to-be-executed quantum program, determining an execution timing of a to-be-mapped logic gate set of the to-be-executed quantum program; a second determining module configured for separately determining cost of mapping each logic gate in the to-be-mapped logic gate set to the topological structures of the quantum chip according to the execution timing and the initial mapping relationship; an adjusting module configured for, according to the cost of mapping each logic gate to the topological structures of the quantum chip, adjusting the target mapping of the to-be-executed quantum program to minimize cost of the target mapping.

Yet another embodiment of the present disclosure provides a storage medium storing a computer program therein, wherein the computer program is configured for executing, when executed, the method described in any one of the foregoing.

Yet another embodiment of the present disclosure provides an electronic device comprising a memory and a processor, the memory stores a computer program therein, and the processor is configured for running the computer program to execute the method described in any one of the foregoing.

Yet another embodiment of the present disclosure provides a quantum computer operating system, characterized in that the quantum computer operating system implements constructing of a to-be-mapped quantum program according to the method described in any one of the foregoing.

Yet another embodiment of the present disclosure provides a quantum computer comprising the quantum computer operating system.

According to an embodiment, it is possible to at least alleviate the impact on the operation of the entire quantum circuit due to the addition of SWAP gates, thereby improving the resource utilization of the entire quantum chip.

According to an embodiment, it is possible to at least alleviate the problem of having an impact on the entire quantum circuit due to a single physical bit factor. In addition, it is possible to determine the optimal mapping circuit for the topological structures of the quantum chip. In addition, it is possible to maximize the resource utilization of the entire quantum chip.

### BRIEF DESCRIPTION OF THE DRAWINGS

FIG. 1 is a structural block diagram of hardware of a computer terminal provided in an embodiment;

FIG. 2 is a schematic flow chart of a mapping method for a quantum program and a quantum chip provided in an embodiment;

FIG. 3 is a schematic diagram of a topological structure of a physical bit of a quantum chip provided in an embodiment;

FIG. 4 is a schematic diagram of a quantum circuit corresponding to an initial quantum program provided in an embodiment;

FIG. 5 is a schematic diagram of a to-be-mapped quantum program equivalent to an initial quantum program provided in an embodiment;

FIG. 6 is a schematic structural diagram of a mapping device for a quantum program and a quantum chip provided in an embodiment;

FIG. 7 is a flowchart of a mapping method for a quantum program and a quantum chip provided in an embodiment;

FIG. 8 is a schematic diagram of a to-be-executed quantum circuit provided in an embodiment;

FIG. 9 is a schematic diagram of a directed acyclic graph corresponding to a to-be-executed quantum circuit provided in an embodiment;

FIG. 10 is a schematic structural diagram of an apparatus for determining the mapping between a quantum program and a quantum chip provided in an embodiment.

### DETAILED DESCRIPTION

The embodiments described below with reference to the accompanying drawings are exemplary and are intended to explain the embodiments only and are not to be construed as limiting the embodiments.

The method of the embodiments can be applied to an electronic device, such as a computer terminal, specifically, an ordinary computer, a quantum computer, etc.

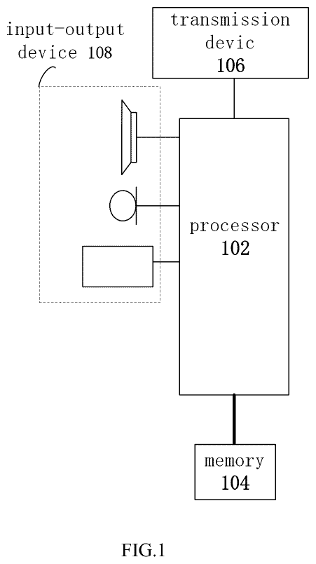

It will be described in detail below by taking running on a computer terminal as an example. FIG. 1 is a structural block diagram of hardware of a computer terminal provided in an embodiment. As shown in FIG. 1, the computer terminal may include one or more (only one is shown in FIG. 1) processors 102 (the processors 102 may include, but are not limited to, a processing device such as a microprocessor MCU or a programmable logic device FPGA) and a memory 104 for storing data. Optionally, the above computer terminal may further include a transmission device 106 and an input-output device 108 for a communication function. Those skilled in the art can understand that the structure shown in FIG. 1 is only schematic, and does not limit the structure of the computer terminal. For example, the computer terminal may also include more or fewer components than shown in FIG. 1, or have a different configuration than shown in FIG. 1.

The memory 104 may be used to store a software program as well as a module for application software, such as program instructions/modules corresponding to a method for constructing a to-be-mapped quantum program in an embodiment of the present application. The processor 102 executes various functional applications as well as data processing, i.e., implements the above-described method, by running the software program as well as the module stored in the memory 104. The memory 104 may include a high-speed random memory, and may also include a non-volatile memory, such as one or more magnetic storage devices, flash memory, or other non-volatile solid-state memory. In some examples, the memory 104 may further include memories set remotely relative to the processor 102, and these remote memories may be connected to the computer terminal via a network. An example of the network includes, but is not limited to, the Internet, an enterprise intranet, a local area network, a mobile communication network, and combinations thereof.

The transmission device 106 is used to receive or send data via a network. A specific example of the above network may include a wireless network provided by a communications provider of a computer terminal. In one example, the transmission device 106 includes a Network Interface Controller (NIC) that may be connected to other network devices via a base station so that it may communicate with the Internet. In one example, the transmission device 106 may be a Radio Frequency (RF) module for communicating wirelessly with the Internet.

It should be noted that when a quantum program runs on a quantum chip (also called a physical chip), for multiple physical bits on the same physical chip, the state of its individual physical bits is unstable. For example, factors such as double-bit quantum logic gate operation noise, measurement noise, and the decoherence time of the physical bits all interfere with the effective utilization of the physical bits, which can have an unknown impact on the operation results of the entire quantum circuit. For example, since the decoherence time of each physical bit is different, if the decoherence time of one physical bit is short and limits the depth of the quantum circuit that can be operated by the whole quantum chip, it will inevitably lead to the waste of resources of other physical bits.

In the prior art, in general, for a double-qubit quantum logic gate that cannot be adapted to two quantum bits on a quantum chip, the double-qubit quantum logic gate that cannot be adapted is converted into a quantum logic gate supportable for that chip by means of adding a SWAP gate to the quantum program. For example, the quantum program contains quantum logic gates CNOT (q1, q3). Although the quantum chip supports CNOT gates, the physical quantum bits q1 and q3 in the quantum chip are not directly connected, and cannot be directly executed. Therefore, the two quantum logic gates in the quantum program need to be swapped with quantum logic gates that can be directly executed by this chip. For example, the quantum program contains CNOT (q1, q3), then the existing swapping method is briefly described as follows: according to the connection relationship between the quantum bits on the quantum chip, finding a connection path between the two quantum bits q1, q3 of the CNOT operation, and assuming that the path passes through the quantum bits q1, q2, the execution of CNOT (q1, q3) is equivalent to the sequential execution of: SWAP (q1, q2), SWAP (q2, q3), CNOT (q2, q3), SWAP (q3, q2), SWAP(q2, q1). Wherein, the SWAP gate denotes the execution of the swap operation on the quantum bits. It can be seen that in order to adapt a double-qubit logic gate to the quantum chip, a large number of new quantum logic gates will be newly added in the swapping process, and the number of quantum logic gates in a quantum program will be even larger after the final swapping, thus greatly reducing the computational efficiency of the quantum program.

Based on this, it is necessary to propose an optimal scheme for constructing a to-be-mapped quantum program for reducing the impact on the operation of the entire quantum circuit due to the addition of SWAP gates, so as to improve the resource utilization of the entire quantum chip.

FIG. 2 shows a flow diagram of a mapping method for a quantum program and a quantum chip provided in an embodiment.

As shown in FIG. 2, S201: obtaining topological structures of physical bits in a quantum chip, a logic gate set of an initial quantum program, and an initial mapping relationship between logic bits and the physical bits.

For example, each quantum chip has its own specific topological structure. The topological structure reflects the entanglement between the various physical bits supported by the quantum chip. At this stage, the number of physical bits in a quantum chip is limited, and the topological structure of the chip is simple, usually in the form of a simple two-dimensional chain (or a one-dimensional chain). A certain physical bit in a quantum chip can only be connected to a finite number of physical bits.

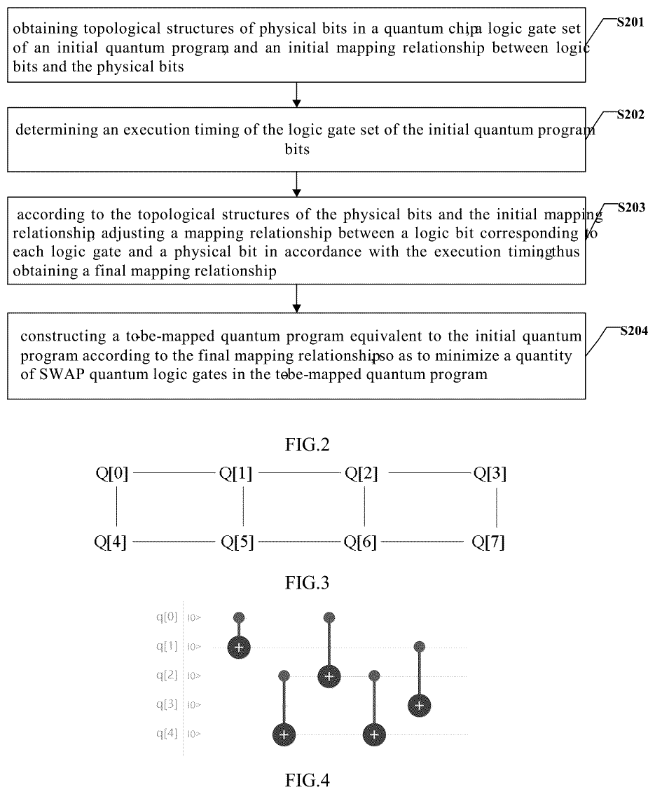

Exemplarily, FIG. 3 shows a schematic diagram of a topological structure of physical bits of a quantum chip provided in an embodiment. The quantum chip includes eight physical bits, namely Q[0], Q[1], Q[2], Q[3], Q[4], Q[5], Q[6], Q[7]. The physical bits may be coupled through a capacitor, and coupling relationships are created only between adjacent physical bits. Specific coupling result is shown in FIG. 3.

The logic gate set of the initial quantum program is mainly composed of tens of or even thousands of quantum logic gates. The logic gate set of the initial quantum program comprises: a first-rule logic gate set and a second-rule logic gate set, wherein the first-rule logic gate set comprises: a single-bit quantum logic gate and a double-bit quantum logic gate with adjacent logic bits; the second-rule logic gate set comprises: a double-bit quantum logic gate with nonadjacent logic bits. The execution process of the initial quantum program is the process of executing all quantum logic gates in accordance with a certain timing.

For easy distinction, generally, the quantum bit structure in the quantum chip is called physical bits, and the object bits operated in the quantum circuit are called logic bits. The initial mapping relationship between logic bits and physical bits refers to the “correspondence” between logic bits and physical bits.

Exemplarily, for an initial quantum program CNOT (q[0], q[1])<<CNOT (q[2], q[4])<<CNOT (q[0], q[2])<<CNOT (q[2], q[4])<<CNOT (q[1], q[3]), the logic bits under its operation are q[0], q[1], q[2], q[3], q[4], and then the initial mapping relationship between logic bits and physical bits can be set to q[0] corresponding to Q[0], q[1] corresponding to Q[1], q[2] corresponding to Q[2], q[3] corresponding to Q[3], q[4] corresponding to Q[4], and so on.

S202: determining an execution timing of the logic gate set of the initial quantum program bits.

A “timing” is a time sequence in which quantum logic gates are executed. “Determining an execution timing of the logic gate set of the initial quantum program bits” comprises the following steps:

S2021: obtaining quantum circuits corresponding to the initial quantum program.

Exemplarily, FIG. 4 is a schematic diagram of a quantum circuit corresponding to an initial quantum program provided in an embodiment. The initial quantum program corresponding to this quantum circuit is CNOT (q[0], q[1])<<CNOT (q[2], q[4])<<CNOT (q[0], q[2])<<CNOT (q[2], q[4])<<CNOT (q[1], q[3]).

S2022: by traversing the quantum circuits, setting an execution timing of the first-rule logic gate set with a first timing of each qubit as a priority execution timing, and setting an execution timing of the second-rule logic gate set with a first timing of each qubit as a second-priority execution timing.

Exemplarily, traversing the quantum circuits as shown in FIG. 4, wherein the logic gate at the first timing is CNOT (q[0], q[1]), CNOT (q[2], q[4]), the logic gate at the second timing is CNOT (q[0], q[2]), the logic gate at the third timing is CNOT (q[2], q[4]), and the logic gate at the fourth timing is CNOT (q[1], q[3]). Therefore, the logic gate set with a first timing of each qubit is CNOT (q[0], q[1]) and CNOT (q[2], q[4]), wherein CNOT (q[0], q[1]) conforms to the characteristics of a first-rule logic gate, and the execution timing thereof is set as a priority execution timing; CNOT (q[2], q[4]) conforms to the characteristics of a second-rule logic gate, and the execution timing thereof is set as a second-priority execution timing.

S2023: deleting logic gates whose execution timing has been classified, and continuing to executing the step “setting an execution timing of the first-rule logic gate set with a first timing of each qubit as a priority execution timing, and setting an execution timing of the second-rule logic gate set with a first timing of each qubit as a second-priority execution timing” until classification of the execution timing of logic gates of the quantum circuit has been accomplished.

Exemplarily, following the above example, deleting logic gates whose execution timing has been classified, that is, deleting CNOT (q[0], q[1]), CNOT (q[2], q[4]). At the moment, the logic gate at the first timing is CNOT (q[0], q[2]), the logic gate at the second timing is CNOT (q[2], q[4]), the logic gate at the third timing is CNOT (q[1], q[3]), and then continuing to executing the step “setting an execution timing of the first-rule logic gate set with a first timing of each qubit as a priority execution timing, and setting an execution timing of the second-rule logic gate set with a first timing of each qubit as a second-priority execution timing”. Therefore, CNOT (q[0], q[2]), CNOT (q[2], q[4]) and CNOT (q[1], q[3]) are all set as the second-priority execution timing, and by this time classification of the execution timing is accomplished.

It should be noted that the initial quantum program may comprise a single-bit quantum logic gate, a double-bit quantum logic gate, and a multi-bit quantum logic gate, but before determining the execution timing of a logic gate set of the initial quantum program, firstly it is necessary to transform the multi-bit quantum logic gates into a combination of the single-bit quantum logic gate(s) and the double-bit quantum logic gate(s). Since the single-bit quantum logic gate can directly map logic bits to physical bits, the single-bit quantum logic gate(s) obtained after the transformation and the single-bit quantum logic gate(s) that exists in the to-be-executed quantum program before the transformation can be deleted (or prioritized for execution); and then, based on the double-bit quantum logic gate(s) obtained after the transformation and the double-bit quantum logic gate(s) that exists in the initial quantum program before the transformation, determining an execution timing of the logic gate set of the initial quantum program bits. Here, for ease of illustration, the above example is given only as an example of a quantum circuit comprising the double-bit quantum logic gate.

S203: according to the topological structures of the physical bits and the initial mapping relationship, adjusting a mapping relationship between a logic bit corresponding to each logic gate and a physical bit in accordance with the execution timing, thus obtaining a final mapping relationship.

According to the topological structures of the physical bits and the initial mapping relationship, forward traversing each logic gate in accordance with the execution timing and adjusting a physical bit mapped to each logic gate under the previous mapping relationship, and adjusting the previous mapping relationship until completion of forward traversing in accordance with the execution timing, thus obtaining a target forward mapping relationship.

Exemplarily, according to the topological structures of the physical bits and the initial mapping relationship shown in FIG. 3, q[0] corresponds to Q[0], q[1] corresponds to Q[1], q[2] corresponds to Q[2], q[3] corresponds to Q[3], and q[4] corresponds to Q[4], and forward traversing CNOT (q[0], q[1]), CNOT (q[2], q[4]), CNOT (q[0], q[2]), CNOT (q[2], q[4]), and CNOT (q[1], q[3]) in accordance with the execution timing. Firstly, forward traversing CNOT (q[0], q[1]) in accordance with the execution timing. Since the logic bits are adjacent, the current mapping relationship does not change. When traversing to CNOT (q[2],q[4]), there is one possible scheme: by inserting a SWAP logic gate between Q[4] and Q[0], and then by inserting a SWAP logic gate between Q[0] and Q[1], the logic bit Q[4] is mapped to the physical bit Q[1], and the purpose of executing CNOT (q[2], q[4]) is achieved. The mapping relationship at this point is: q[0]—Q[4], q[1]—Q[0], q[2]—Q[2], q[3]—Q[3], and q[4]—Q[1]. Continue traversing to CNOT (q[0], q[2]). Based on the current mapping relationship, the logic bit q[2] can be mapped to the physical bit Q[3] by inserting a SWAP logic gate between Q[2] and Q[3] to achieve the purpose of executing CNOT (q[0], q[2]). The mapping relationship at this point is: q[0]—Q[4], q[1]—Q[0], q[3]—Q[2], q[2]—Q[3], and q[4]—Q[1]. Continue traversing to CNOT (q[2], q[4]). Based on the current mapping relationship, the logic bit q[2] can be mapped to the physical bit Q[2] by inserting a SWAP logic gate between Q[2] and Q[3] to achieve the purpose of executing CNOT (q[2], q[4]). The mapping relationship at this point is: q[0]—Q[4], q[1]—Q[0], q[2]—Q[2], q[3]—Q[3], and q[4]—Q[1]. Continuing traversing to CNOT (q[1], q[3]). Based on the current mapping relationships, the logic bit q[3] can be mapped to the physical bit Q[1] by inserting a SWAP logic gate between Q[2] and Q[3] and then inserting a SWAP logic gate between Q[1] and Q[2], so as to achieve the purpose of executing CNOT (q[1], q[3]). The target forward mapping relationships obtained at this point are q[0]—Q[4], q[1]—Q[0], q[2]—Q[3], and q[3]—Q[1].

According to the target forward mapping relationship, backward traversing each logic gate in accordance with the execution timing and adjusting a physical bit mapped to each logic gate under the previous mapping relationship, and adjusting the previous mapping relationship until completion of backward traversing in accordance with the execution timing, thus obtaining a target backward mapping relationship as the final mapping relationship.

Following the above example, the target forward mapping relationships are q[0]—Q[4], q[1]—Q[0], q[4]—Q[2], q[2]—Q[3], and q[3]—Q[1]. Backward traversing CNOT (q[1], q[3]), CNOT (q[2], q[4]), CNOT (q[0], q[2]), CNOT (q[2], q[4]), and CNOT (q[0], q[1]) in accordance with the execution timing. Adjusting a physical bit mapped to each logic gate under the previous mapping relationship. For example, adjusting a physical bit mapped to CNOT (q[1], q[3]) under the current target forward mapping relationships. Subsequently adjusting the previous mapping relationship, that is, the current target forward mapping relationships. Continuing adjusting the physical bits mapped to each of the remaining logic gates under the previous mapping relationship until completion of backward traversing in accordance with the execution timing to obtain the target backward mapping relationships, that is, q[0]—Q[4], q[1]—Q[0], q[4]—Q[2], q[2]—Q[3], and q[3]—Q[1], as the final mapping relationship.

S204: constructing a to-be-mapped quantum program equivalent to the initial quantum program according to the final mapping relationship, so as to minimize a quantity of SWAP quantum logic gates in the to-be-mapped quantum program.

According to the final mapping relationship, a SWAP quantum logic gate, which is generated accordingly by running each logic gate in accordance with the execution timing, is inserted at the corresponding position in the quantum logic gate set. The quantum program obtained after insertion is determined to be a to-be-mapped quantum program equivalent to the initial quantum program.

Exemplarily, a SWAP quantum logic gate, which is generated accordingly by running each logic gate in accordance with the execution timing, is inserted at the corresponding position in the quantum logic gate set. FIG. 5 is a schematic diagram of a to-be-mapped quantum program equivalent to an initial quantum program provided in an embodiment. By inserting a SWAP logic gate between Q[4] and Q[0], and then by inserting a SWAP logic gate between Q[0] and Q[1], the logic bit Q[4] is mapped to the physical bit Q[1]. By inserting a SWAP logic gate between Q[2] and Q[3], the logic bit q[2] is mapped to the physical bit Q[3]. By inserting a SWAP logic gate between Q[2] and Q[3], the logic bit q[2] is mapped to the physical bit Q[2]. By inserting a SWAP logic gate between Q[2] and Q[3], and then inserting a SWAP logic gate between Q[1] and Q[2], the to-be-mapped quantum program equivalent to the initial quantum program is obtained, so that the number of SWAP quantum logic gates in the to-be-mapped quantum program is the smallest. The black dots in the diagram represent control bits of the CNOT gate, the “+” in the black circle represents target bits of the CNOT gate, and the two “X” are connected by a vertical bar and represent the schematic diagram of the SWAP logic gate.

It should be noted that there may be multiple schemes for introducing a SWAP logic gate between two non-adjacent bits. However, each scheme varies in fidelity, noise, etc., and only the scheme with a small number of SWAP logic gates and high fidelity can effectively ensure the execution accuracy of the to-be-executed quantum circuit. If the logic bits with fewer operations can be mapped to the physical bits with the shorter decoherence time during the mapping process, it is possible to maximize the resource utilization of the physical bits and improve the operation accuracy of the quantum circuit. Therefore, the execution accuracy of the quantum circuit can be effectively ensured only by selecting a logic bit with high fidelity, fewer number of SWAP logic gates introduced, and fewer operations to map to a physical bit with shorter decoherence time.

According to one embodiment, it is be possible to at least mitigate the impact on the operation of the entire quantum circuit due to the addition of the SWAP gate, thereby improving the resource utilization of the entire quantum chip.

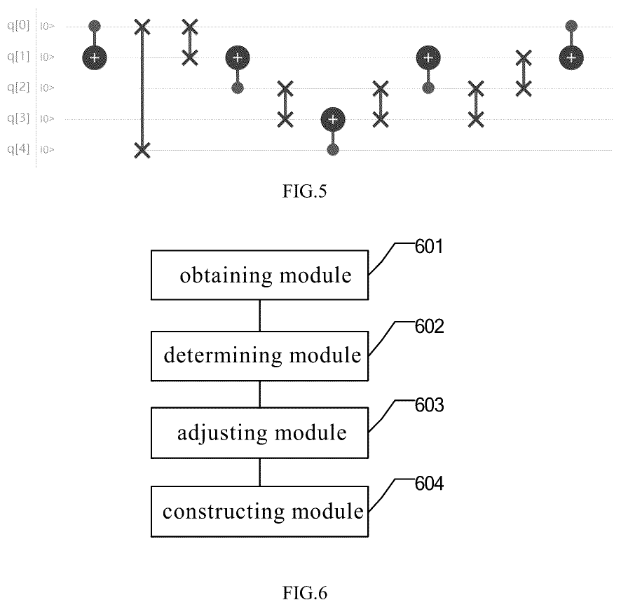

FIG. 6 is a schematic structural diagram of a mapping device for a quantum program and a quantum chip provided in an embodiment. Corresponding to the process shown in FIG. 2, the device may comprise: an obtaining module 601 configured for obtaining topological structures of physical bits in a quantum chip, a logic gate set of an initial quantum program, and an initial mapping relationship between logic bits and the physical bits; a determining module 602 configured for determining an execution timing of the logic gate set of the initial quantum program; an adjusting module 603 configured for according to the topological structures of the physical bits and the initial mapping relationship, adjusting a mapping relationship between a logic bit corresponding to each logic gate and a physical bit in accordance with the execution timing, thus obtaining a final mapping relationship; a constructing module 604 configured for constructing a to-be-mapped quantum program equivalent to the initial quantum program according to the final mapping relationship, so as to minimize a quantity of SWAP quantum logic gates in the to-be-mapped quantum program.

For example, the determining module comprises: an obtaining unit configured for obtaining quantum circuits corresponding to the initial quantum program; a traversing unit configured for by traversing the quantum circuits, setting an execution timing of the first-rule logic gate set with a first timing of each qubit as a priority execution timing, and setting an execution timing of the second-rule logic gate set with a first timing of each qubit as a second-priority execution timing; an iteration unit configured for deleting logic gates whose execution timing has been classified, and continuing to executing the step “setting an execution timing of the first-rule logic gate set with a first timing of each qubit as a priority execution timing, and setting an execution timing of the second-rule logic gate set with a first timing of each qubit as a second-priority execution timing” until classification of the execution timing of logic gates of the quantum circuit has been accomplished.

For example, the adjusting unit comprises: a first execution unit configured for according to the topological structures of the physical bits and the initial mapping relationship, forward traversing each logic gate in accordance with the execution timing and adjusting a physical bit mapped to each logic gate under the previous mapping relationship, and adjusting the previous mapping relationship until completion of forward traversing in accordance with the execution timing, thus obtaining a target forward mapping relationship; a second execution unit configured for according to the target forward mapping relationship, backward traversing each logic gate in accordance with the execution timing and adjusting a physical bit mapped to each logic gate under the previous mapping relationship, and adjusting the previous mapping relationship until completion of backward traversing in accordance with the execution timing, thus obtaining a target backward mapping relationship as the final mapping relationship.

For example, the constructing module comprises: an inserting unit configured for according to the final mapping relationship, inserting a SWAP quantum logic gate generated accordingly by operating each logic gate in accordance with the execution timing at a corresponding position in the quantum logic gate set, and determining a quantum program obtained after the inserting is completed as the to-be-mapped quantum program equivalent to the initial quantum program.

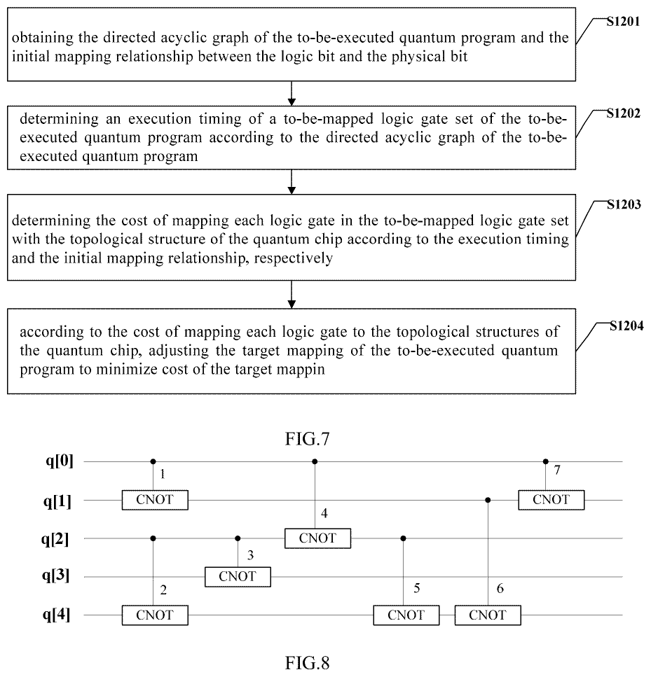

Referring to FIG. 7, FIG. 7 is a flowchart of a mapping method for a quantum program and a quantum chip provided in an embodiment.

As shown in FIG. 7, S1201: obtaining the directed acyclic graph of the to-be-executed quantum program and the initial mapping relationship between the logic bit and the physical bit.

The to-be-executed quantum program is mainly composed of tens of hundreds or even thousands of quantum logic gates. The execution process of the quantum program is the process of executing all quantum logic gates in accordance with a certain timing. It should be noted that timing is the order in which a single quantum logic gate is executed.

FIG. 3 is a schematic diagram of a topological structure of a physical bit of a quantum chip provided in an embodiment. The description of FIG. 3 will not be repeated.

Exemplarily, for a quantum program CNOT (q[0], q[1])<<CNOT (q[2], q[4])<<CNOT (q[2], q[3])<<CNOT (q[0], q[2])<<CNOT (q[2], q[4])<<CNOT (q[1], q[4])<<CNOT (q[0], q[1]), the logic bits under its operation are q[0], q[1], q[2], q[3], q[4], and then the initial mapping relationship between logic bits and physical bits can be set to q[0] corresponding to Q[0], q[1] corresponding to Q[1], q[2] corresponding to Q[2], q[3] corresponding to Q[3], q[4] corresponding to Q[4], and so on.

A directed acyclic graph (DAG graph) is a type of directed graph, which literally means that the graph has no loops and is a loop-free directed graph. If there is a non-directed acyclic graph that starts at point A and goes to B and passes through C to get back to point A, it forms a loop. If the direction from point C to point A is changed to from point A to point C, the graph becomes a directed acyclic graph. The directed acyclic graphs are often used to represent driving dependencies between events, scheduling between tasks, and so on.

“Obtaining a directed acyclic graph of a to-be-executed quantum program” comprises, e.g., the following steps.

S12011: obtaining nodes in the to-be-executed quantum program.

A quantum program can be understood as a sequence of operations, which mainly comprises quantum logic gates, measurement operations, etc. The “node” in the quantum program refers to the data of a specific structure in the relative position of the whole program, and can be a quantum logic gate, a measurement operation, etc. In this application, the quantum logic gate node is mainly focused on.

For example, it is possible to obtain the quantum logic gate node in the quantum program by traversing the nodes of a quantum program.

For example, FIG. 8 is a schematic diagram of a to-be-executed quantum circuit provided in an embodiment. It can be understood that a quantum program as a whole corresponds to a total quantum circuit, and the to-be-executed quantum program refers to the total quantum circuit. For example, the to-be-executed quantum program is CNOT (q[0], q[1])<<CNOT (q[2], q[4])<<CNOT (q[2], q[3])<<CNOT (q[0], q[2])<<CNOT (q[2], q[4])<<CNOT (q[1], q[4])<<CNOT (q[0], q[1]). Traversing from CNOT (q[0], q[1]), nodes 1 to 7 in the to-be-executed quantum program obtained are CNOT (q[0], q[1]), CNOT (q[2], q[4]), CNOT (q[2], q[3]), CNOT (q[0], q[2]), CNOT (q[2], q[4]), CNOT (q[1], q[4]), CNOT (q[0], q[1]).

S12012: determining the association relationship between the nodes according to the qubits operated by the nodes.

For each quantum operation node, determining the next node relative to the node from all quantum operation nodes executed sequentially by qubits operated by the node, and thus obtaining the adjacency relationship between the node and the next node.

In the process of traversing the nodes of the quantum circuit, recording the quantum bit sequence number and unique identifier of a currently traversed node operation, so as to update the last node corresponding to each bit in the process of traversing. Recording the information of the last node corresponding to each bit and the node to which is currently being traversed, and the adjacency relationship between the last node and the node to which is currently being traversed. The last node corresponding to the qubit refers to the precursor node of the quantum logic gate node that is currently being traversed.

It should be noted that the unique identifier of the quantum logic gate is marked according to the execution timing of the quantum logic gate.

Exemplarily, FIG. 8 is a schematic diagram of a to-be-executed quantum circuit. First, the nodes of the quantum program are traversed sequentially according to the qubits operated by the nodes. Starting from the first layer of the quantum circuit, traversing CNOT (q[0],q[1]), quantum bit sequence numbers of whose gate operation are 0 and 1, and the unique identifier of which is “1”; CNOT (q[2],q[4]), quantum bit sequence numbers of whose gate operation are 2 and 4, and unique identifier of which is “2” and none of the current first-layer CNOT gates has the predecessor node.

When traversing to the beginning of the second layer of the quantum circuit, i.e., to the node CNOT(q[2],q[3]), quantum bit sequence numbers of CNOT gate operation are 2 and 3, and the unique identifier of which is 3. At this point the predecessor node of CNOT (q[2], q[3]) is CNOT (q[2], q[4]). The adjacency relationship between the bits is recorded in the form of the unique identifier that can be denoted as {2,3}, indicating that node 2 and node 3 are adjacent. Then, traversing to the CNOT (q[0], q[2]) of the third layer, the CNOT (q[2], q[4]) of the fourth layer, the CNOT (q[1], q[4]) of the fifth layer, and the CNOT (q[0], q[1]) of the sixth layer sequentially, thereby obtaining the qubits of the node operations of each layer and determining the association relationship between the nodes. The same goes for the processing process, which will not be repeated herein.

S12013: generating a directed acyclic graph corresponding to the to-be-executed quantum program according to the association relationship between the nodes. A vertex in the directed acyclic graph represents a node. A side of the directed acyclic graph represents the association relationship between the nodes. The direction of the edge represents the executed timing relationship of the nodes corresponding to the vertices connected with the edge.

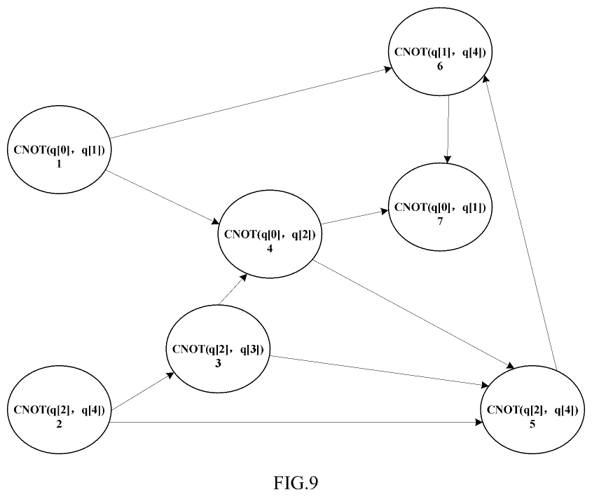

Referring to FIG. 9, FIG. 9 is a schematic diagram of a directed acyclic graph corresponding to a to-be-executed quantum circuit provided in an embodiment. By constructing vertices corresponding to quantum operation nodes and constructing the edge between the vertices corresponding to the nodes with adjacency relationship, wherein the direction of the edge is pointed from the vertex of the previous node in the nodes with the adjacency relationship to the vertex corresponding to the next node, and then according to the association relationship between the nodes, the directed acyclic graph corresponding to the to-be-executed quantum program is generated.

S1202: determining an execution timing of a to-be-mapped logic gate set of the to-be-executed quantum program according to the directed acyclic graph of the to-be-executed quantum program.

Said “determining an execution timing of a to-be-mapped logic gate set of the to-be-executed quantum program” comprises:
according to the directed acyclic graph of the to-be-executed quantum program, setting the execution timing of the first-rule logic gate set of the node whose indegree in the directed acyclic graph is zero as the first priority, and setting the execution timing of the second-rule logic gate set of the node whose indegree in the directed acyclic graph is zero as the second priority.

As described above, the to-be-executed quantum program or initial quantum program may include a single-bit quantum logic gate, a double-bit quantum logic gate, and a multi-bit quantum logic gate.

Exemplarily, FIG. 9 is a schematic diagram of a directed acyclic graph corresponding to a to-be-executed quantum circuit provided in an embodiment. According to the directed acyclic graph shown in FIG. 9, the nodes whose indegree is zero are CNOT (q[0], q[1]) and CNOT (q[2], q[4]) respectively. The logic bits under its operation by CNOT (q[0], q[1]) are adjacent and are the first-rule logic gates, and thus setting the execution timing of the first-rule logic gate as the first priority. The logic bits under its operation by CNOT (q[2], q[4]) are nonadjacent and are the second-rule logic gates, and thus setting the execution timing of the second-rule logic gate as the second priority.

Deleting the first-rule logic gate set whose execution timing has been classified, and continuing to executing the step “setting the execution timing of the first-rule logic gate set of the nodes whose indegree in the directed acyclic graph is zero as the first priority; setting the execution timing of the second-rule logic gate set of the nodes whose indegree in the directed acyclic graph is zero as the second priority” until classification of the execution timing of the to-be-mapped logic gate set has been accomplished.

Following the preceding example, since the first-rule logic gate set does not affect the resource utilization of the whole quantum circuit during the operation and can be executed directly, it is possible to delete first-rule logic gate set whose execution timing has been classified during classification of the execution timing, that is, deleting CNOT (q[0], q[1]). Continuing to executing the step “setting the execution timing of the first-rule logic gate set of the nodes whose indegree in the directed acyclic graph is zero as the first priority; setting the execution timing of the second-rule logic gate set of the nodes whose indegree in the directed acyclic graph is zero as the second priority”. Finally, classification of the execution timing has been accomplished. The logic gate set of the first priority comprises: CNOT (q[0], q[1]), CNOT (q[2], q[3]) and CNOT (q[0], q[1]). The logic gate set of the second priority comprises: CNOT (q[2], q[4]), CNOT (q[0], q[2]), CNOT (q[2], q[4]) and CNOT (q[1], q[4]).

S1203: determining the cost of mapping each logic gate in the to-be-mapped logic gate set with the topological structure of the quantum chip according to the execution timing and the initial mapping relationship, respectively.

The cost of mapping each logic gate with the topological structure of the quantum chip can be divided into a fixed cost and a swapping cost. The fixed cost can include decoherence time of a quantum chip bit, fidelity, etc. The swapping cost includes the number of swap gates that need to be introduced for mapping all the gates in the to-be-mapped logic gate set. It should be noted that since the fixed cost of the quantum chip is determined by the physical characteristics of the chip in the process of running the quantum circuit, only the swapping cost of running the quantum circuit in the quantum chip can be considered as an example.

“Determining the cost of mapping each logic gate in the to-be-mapped logic gate set with the topological structure of the quantum chip according to the execution timing and the initial mapping relationship, respectively”, comprises:

1. obtaining a mapping scheme for mapping each logic gate with the topological structure of the quantum chip respectively according to the execution timing and the initial mapping relationship.

First, converting the to-be-executed quantum circuit to a directed acyclic graph structure. Then, selecting the node whose indegree is zero is selected from the corresponding directed acyclic graph, which can be noted as operation layer and indicates the quantum logic gate operation to be executed currently. Next, carrying out an iterative looping process: judging whether the operation layer is empty; if the operation layer is empty, it means that the mapping of the whole to-be-executed quantum circuit has been completed, and the mapping is complete; if the operation layer is not empty, looking up, from the operation layer, logic gates that can be directly executed, which means that according to the current mapping relationship, the logic bits can be directly mapped to the logic gates of the physical bits without introducing any swap logic gate operation; if there is a logic gate that can be directly executed in the operation layer, the logic gate that can be directly executed is deleted from the operation layer, then updating operation layer according to the gate following the logic gate that can be executed directly, and returning to the beginning of the loop to start a second iteration loop; if there is no logic gate that can be directly executed in the operation layer, this means that under the current mapping conditions, it is not possible to map the logic gates in the operation layer, and it is necessary to introduce the swap logic gate operation for changing the mapping relationship and realizing the quantum state transfer, thus improving the current mapping environment.

Exemplarily, please refer to the directed acyclic graph shown in FIG. 9, first determining the nodes of the quantum logic gates to be executed currently in the operation layer as CNOT (q[0], q[1]) and CNOT (q[2], q[4]), respectively. Looking up the logic gate that can be executed directly, that is, CNOT (q[0], q[1]), and then deleting CNOT (q[0], q[1]) from the operation layer. Then, updating the operation layer according to the gates CNOT (q[0], q[2]), CNOT (q[1], q[4]) following the logic gate CNOT (q[0], q[1]) that can be executed directly. Since the non-zero indegree of the current CNOT (q[0], q[2]), CNOT (q[1], q[4]), it cannot be updated to the operation layer for the time being, i.e., the current operation layer remains CNOT (q[2], q[4]) and goes back to the start position of the loop. The second iterative loop is started with the above steps until there are no logic gates in the operation layer that can be directly executed. At this point, the swap logic gate operation is introduced to dynamically adjust the mapping relationship of the to-be-executed quantum program to improve the current mapping environment.

Exemplarily, according to initial mapping relationships q[0]—Q[0], q[1]—Q[1], q[2]—Q[2], q[3]—Q[3], q[4]—Q[4], if CNOT (q[2], q[4]) is to be executed at this point, there are various schemes for introducing the swap logic gates. For example: by inserting a swap logic gate between Q[4] and Q[0], and then by inserting a swap logic gate between Q[0] and Q[1], the logic bit Q[4] is mapped to the physical bit Q[1], and the purpose of executing CNOT (q[2], q[4]) is achieved. The mapping relationships at this point are q[0]—Q[4], q[1]—Q[0], q[2]—Q[2], q[3]—Q[3], and q[4]—Q[1]. Alternatively, by inserting a swap logic gate between Q[2] and Q[1], and then by inserting a swap logic gate between Q[0] and Q[1], the logic bit Q[2] is mapped to the physical bit Q[0], and the purpose of executing CNOT (q[2], q[4]) is also achieved. The mapping relationships at this point are q[0]—Q[1], q[1]—Q[2], q[2]—Q[0], q[3]—Q[3], and q[4]—Q[1]. It should be noted that the logic gates of the operation layer are all the nodes whose indegree is zero, and there are many other mapping schemes that realize the execution of CNOT (q[2], q[4]), which will not be exhaustively enumerated herein. However, in the practical application of the present application, it is necessary to look up all the feasible schemes for inserting swaps, and then determine the final target mapping by evaluating the different costs of each mapping scheme.

2. constructing a cost formula for evaluating the mapping schemes and calculating cost of the mapping schemes.

Optionally, a cost formula for a mapping scheme can be constructed:

$${F}_{c o s t} = {a}_{1} * \frac{1}{{T}_{2}} + {a}_{2} * {G}_{s w a p} + {a}_{3} * ( 1 - {f}_{d o u b l e} ) + {a}_{4} * ( 1 - {f}_{m e a s u r e} )$$

The cost of each mapping scheme is evaluated by the above cost formula, considering various factors such as shortest path, fidelity of a double-bit quantum logic gate, measuring fidelity and decoherence time. The final consumption cost of each swap scheme is obtained by weighted summation. Finally, the swap gate insertion scheme with the least cost is selected to update the current mapping. T₂ is decoherence time of a quantum chip bit, G_{swap} is a quantity of swap logic gates required to be introduced for mapping all logic gates in logic gate set to be mapped, f_{double} is fidelity of a double-bit quantum logic gate, fₘₑₐₛᵤᵣₑ is measuring fidelity, and a₁, a₂, a₃, a₄ are preset weight coefficients for the cost formula.

S1204: according to the cost of mapping each logic gate to the topological structures of the quantum chip, adjusting the target mapping of the to-be-executed quantum program to minimize cost of the target mapping.

According to the topological structure of the quantum chip and the initial mapping relationship, forward traversing each logic gate in accordance with the execution timing and calculating the cost of mapping each logic gate with the topological structure of the quantum chip, dynamically adjusting a mapping relationship of the to-be-executed quantum program until completion of forward traversing in accordance with the execution timing, thus obtaining a target forward mapping relationship.

According to the target forward mapping relationship, backward traversing each logic gate in accordance with the execution timing and calculating the cost of mapping each logic gate with the topological structure of the quantum chip, dynamically adjusting a mapping relationship of the to-be-executed quantum program until completion of backward traversing in accordance with the execution timing, thus obtaining a target backward mapping relationship.

Continuing forward and backward alternating iterative mapping and repeating the step “dynamically adjusting a mapping relationship of the to-be-executed quantum program” so as to minimize the cost of target mapping.

Exemplarily, FIG. 4 is a schematic diagram of another to-be-executed quantum circuit provided in an embodiment. According to initial mapping relationships q[0]—Q[0], q[1]—Q[1], q[2]—Q[2], q[3]—Q[3], q[4]—Q[4], forward traversing CNOT (q[0], q[1]), CNOT (q[2], q[4]), CNOT (q[0], q[2]), CNOT (q[2], q[4]) and CNOT (q[1], q[3]) in accordance with the execution timing. Firstly, forward traversing CNOT (q[0], q[1]) in accordance with the execution timing. The current mapping relationship does not change since the logic gates are adjacent. When traversing to CNOT (q[2],q[4]), there is one possible scheme: by inserting a swap logic gate between Q[4] and Q[0], and then by inserting a swap logic gate between Q[0] and Q[1], the logic bit Q[4] is mapped to the physical bit Q[1], and the purpose of executing CNOT (q[2], q[4]) is achieved. The mapping relationships at this point are q[0]—Q[4], q[1]—Q[0], q[2]—Q[2], q[3]—Q[3], and q[4]—Q[1]. Continue traversing to CNOT (q[0], q[2]). Based on the current mapping relationships, the logic bit q[2] can be mapped to the physical bit Q[3] by inserting a swap logic gate between Q[2] and Q[3] to achieve the purpose of executing CNOT (q[0], q[2]). The mapping relationships at this point are q[0]—Q[4], q[1]—Q[0], q[3]—Q[2], q[2]—Q[3], and q[4]—Q[1]. Continue traversing to CNOT (q[2], q[4]). Based on the current mapping relationships, the logic bit q[2] can be mapped to the physical bit Q[2] by inserting a swap logic gate between Q[2] and Q[3] to achieve the purpose of executing CNOT (q[2], q[4]). The mapping relationships at this point are q[0]—Q[4], q[1]—Q[0], q[2]—Q[2], q[3]—Q[3], and q[4]—Q[1]; continuing traversing to CNOT (q[1], q[3]). Based on the current mapping relationships, the logic bit q[3] can be mapped to the physical bit Q[1] by inserting a swap logic gate between Q[2] and Q[3] and then inserting a swap logic gate between Q[1] and Q[2], so as to achieve the purpose of executing CNOT (q[1], q[3]). The target forward mapping relationships obtained at this point are q[0]—Q[4], q[1]—Q[0], q[4]—Q[2], q[2]—Q[3] and q[3]—Q[1].

At this point, the target forward mapping relationships are q[0]—Q[4], q[1]—Q[0], q[4]—Q[2], q[2]—Q[3] and q[3]—Q[1]. Backward traversing CNOT (q[1], q[3]), CNOT (q[2], q[4]), CNOT (q[0], q[2]), CNOT (q[2], q[4]) and CNOT (q[0], q[1]) in accordance with the execution timing. Calculating the cost of mapping each logic gate with topological structure of the quantum chip. Dynamically adjusting the mapping relationship of the to-be-executed quantum program, such as adjusting the physical bits mapped by CNOT (q[1],q[3]) under the current target forward mapping relationship. Subsequently, adjusting the previous mapping relationship, that is, the current target forward mapping relationship. Continuing to adjust the physical bits mapped by each of the remaining logic gates under the previous mapping relationship until completion of backward traversing in accordance with the execution timing, thus obtaining a target backward mapping relationship, that is, q[0]—Q[4], q[1]—Q[0], q[4]—Q[2], q[2]—Q[3] and q[3]—Q[1].

Continuing forward and backward alternating iterative mapping and repeating the step “dynamically adjusting a mapping relationship of the to-be-executed quantum program”, and in accordance with the following cost formula:

$${F}_{c o s t} = {a}_{1} * \frac{1}{{T}_{2}} + {a}_{2} * {G}_{s w a p} + {a}_{3} * ( 1 - {f}_{d o u b l e} ) + {a}_{4} * ( 1 - {f}_{m e a s u r e} )$$

Calculating the mapping cost for each mapping scheme so that the cost of the target mapping is minimized.

It should be noted that there may be multiple schemes for introducing a swap logic gate between two non-adjacent bits. However, each scheme varies in fidelity, noise, etc., and only the scheme with a small number of swap logic gates and high fidelity can effectively ensure the execution accuracy of the to-be-executed quantum circuit. If the logic bits with fewer operations can be mapped to the physical bits with the shorter decoherence time during the mapping process, it is possible to maximize the resource utilization of the physical bits and improve the operation accuracy of the quantum circuit. Therefore, the execution accuracy of the quantum circuit can be effectively ensured only by presetting a weight coefficient and selecting a logic bit with high fidelity, fewer number of swap logic gates introduced, and fewer operations to map to a physical bit with shorter decoherence time.

For the whole mapping algorithm, the to-be-executed quantum circuit can be mapped twice in forward order and once in backward order. This is an idea of a bidirectional heuristic mapping algorithm. A mapping problem of quantum circuits is an NP-hard problem in the scenario of the quantum circuit with high-bit and high-depth. Therefore, in the scenario of the quantum circuit with high-bit and high-depth, the possibility of finding the optimal solution is extremely small, and the bidirectional heuristic mapping algorithm is the mainstream idea to solve the problem. The main method of the bidirectional heuristic mapping algorithm is to give an initial mapping relationship randomly, and then gradually iterate the optimization to continuously approximate the optimal solution, and theoretically the more iterations, the better the optimization effect. The initial mapping determines the starting point for optimizing the algorithm, so a finite number of iterations can be carried out considering the time cost, and then the initial mapping will have a great impact on the final mapping result. However, based on that fact that the prior art cannot give an initial mapping for overall consideration, the global logic gate information in the whole to-be-executed quantum circuit can be comprehensively considered through the forward and reverse mapping. First, a forward traversal mapping is performed through the random mapping to obtain a target forward mapping relationship, and the initial mapping is then updated by performing a traversal mapping once in backward order through the target forward mapping relationship. The cost of the target mapping is minimized by continually performing forward and backward alternating iterative mapping or a finite number of forward and backward alternating iterative mapping.

Compared to the prior art, the present application first obtains a directed acyclic graph of the to-be-executed quantum program and an initial mapping relationship between logic bits and physical bits, determines the execution timing of the to-be-executed logic gate set of the to-be-executed quantum program based on the directed acyclic graph of the to-be-executed quantum program; determines the respective cost of mapping each logic gate in the to-be-mapped logic gate set with the topological structure of the quantum chip based on the execution timing and the initial mapping relationship; and adjusts the target mapping of the to-be-executed quantum program based on the cost of mapping each logic gate with the topological structure of the quantum chip, so as to minimize the cost of the target mapping, solve the problem of the impact of a single physical bit factor on the whole quantum circuit, and determine the optimal mapping circuit of the topological structure of the quantum chip such that the resource utilization of the whole quantum chip is maximized.

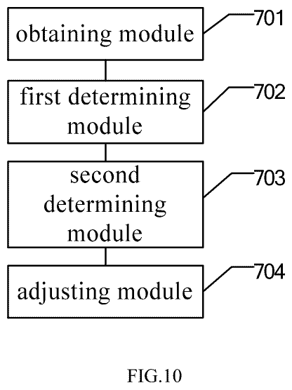

FIG. 10 is a schematic structural diagram of a mapping device for a quantum program and a quantum chip provided in an embodiment. Corresponding to the flow shown in FIG. 7, the device may include:
an obtaining module 701 configured for obtaining a directed acyclic graph of a to-be-executed quantum program and an initial mapping relationship between logic bits and the physical bits;
a first determining module 702 configured for according to the directed acyclic graph of the to-be-executed quantum program, determining an execution timing of a to-be-mapped logic gate set of the to-be-executed quantum program;
a second determining module 703 configured for separately determining cost of mapping each logic gate in the to-be-mapped logic gate set to the topological structures of the quantum chip according to the execution timing and the initial mapping relationship;
an adjusting module 704 configured for according to the cost of mapping each logic gate to the topological structures of the quantum chip, adjusting the target mapping of the to-be-executed quantum program to minimize cost of the target mapping.

The obtaining unit comprises:
an obtaining unit configured for obtaining nodes in the to-be-executed quantum program;
a determining unit configured for determining the association relationship between the nodes according to the qubits operated by the nodes;
a generating unit configured for generating a directed acyclic graph corresponding to the to-be-executed quantum program according to the association relationship between the nodes, wherein a vertex in the directed acyclic graph represents a node, a side of the directed acyclic graph represents the association relationship between the nodes, and the direction of the edge represents the executed timing relationship of the nodes corresponding to the vertices connected with the edge.

The first determining module comprises:
a partitioning unit configured for according to the directed acyclic graph of the to-be-executed quantum program, setting the execution timing of the first-rule logic gate set of the node whose indegree in the directed acyclic graph is zero as the first priority, and setting the execution timing of the second-rule logic gate set of the node whose indegree in the directed acyclic graph is zero as the second priority
an iteration unit configured for deleting the first-rule logic gate set whose execution timing has been classified, and continuing to executing the step “setting the execution timing of the first-rule logic gate set of the nodes whose indegree in the directed acyclic graph is zero as the first priority; setting the execution timing of the second-rule logic gate set of the nodes whose indegree in the directed acyclic graph is zero as the second priority” until classification of the execution timing of the to-be-mapped logic gate set has been accomplished.

The second determining module comprises:
a mapping unit configured for obtaining the mapping scheme for mapping each logic gate with the topological structure of the quantum chip according to the execution timing and the initial mapping relationship, respectively
an evaluating unit configured for constructing a cost formula for evaluating the mapping schemes and calculating cost of the mapping schemes.

The adjusting module comprises:
a forward traversing unit configured for according to the topological structure of the quantum chip and the initial mapping relationship, forward traversing each logic gate in accordance with the execution timing and calculating the cost of mapping each logic gate with the topological structure of the quantum chip, dynamically adjusting a mapping relationship of the to-be-executed quantum program until completion of forward traversing in accordance with the execution timing, thus obtaining a target forward mapping relationship;
a backward traversing unit configured for according to the target forward mapping relationship, backward traversing each logic gate in accordance with the execution timing and calculating the cost of mapping each logic gate with the topological structure of the quantum chip, dynamically adjusting a mapping relationship of the to-be-executed quantum program until completion of backward traversing in accordance with the execution timing, thus obtaining a target backward mapping relationship;
an adjusting unit configured for continuing forward and backward alternating iterative mapping and repeating the step “dynamically adjusting a mapping relationship of the to-be-executed quantum program” so as to minimize the cost of target mapping.

According to one embodiment, it is possible to at least alleviate the problem of having an impact on the entire quantum circuit due to a single physical bit factor. In addition, it is possible to determine the optimal mapping circuit for the topological structures of the quantum chip. In addition, the resource utilization of the whole quantum chip is maximized.

The embodiment also provides a storage medium having a computer program stored therein, wherein the computer program is configured for executing, when run, the steps of a method embodiment of any of the above.

The above storage medium can be set up to store the computer programs used to execute the mapping method in FIG. 2 or 7.

In the present embodiment, the storage medium may include, but is not limited to: a USB flash drive, a read-only memory (ROM), a random access memory (RAM), a mobile hard disk, a diskette or a compact disc, and other media that can store computer programs.

The embodiment also provides an electronic device, comprising a memory and a processor, in which a computer program is stored, and the processor is configured for running the computer program to execute the steps of a method embodiment of any of the above.

The electronic device may further comprise a transmission device and an input-output device, wherein the transmission device is connected to the processor, and the input-output device is connected to the processor.

The processor may be configured to perform the steps of FIG. 2 or 7 by means of a computer program.

The embodiment also provides a quantum computer operating system, and the quantum computer operating system constructs a to-be-mapped quantum program according to any one of the method embodiment provided by the embodiment.

The embodiment of the present application further provides a quantum computer, and the quantum computer comprises the quantum computer operating system.

The above embodiments shown in accordance with the schemas detail the structure, characteristics, and effects of the present disclosure, and the above is only a preferred embodiment, but the embodiments do not limit the scope of embodiment as shown in the accompanying drawings. Any alteration made in accordance with the conception of the embodiments, or modified to an equivalent embodiment of the change, shall be within the scope of protection of the present disclosure if it is not beyond the spirit covered by the description and accompanying drawings.

1. A mapping method for a quantum program and a quantum chip, comprising:
obtaining topological structures of physical bits in the quantum chip, a logic gate set of an initial quantum program, and an initial mapping relationship between logic bits and the physical bits;
determining an execution timing of the logic gate set of the initial quantum program;
adjusting a mapping relationship between each of the logic bits corresponding to each logic gate of the logic gate set and one of the physical bits in accordance with the execution timing according to the topological structures of the physical bits and the initial mapping relationship, thus obtaining a final mapping relationship; and
constructing a to-be-mapped quantum program equivalent to the initial quantum program according to the final mapping relationship, such that each of the logic gates in the logic gate set maps to the topological structures of the physical bits at a lowest cost;
wherein the adjusting a mapping relationship comprises:
according to the topological structures of the physical bits and the initial mapping relationship, forward traversing each of the logic gates in accordance with the execution timing and adjusting the physical bit mapped to each of the logic gates under a previous mapping relationship, and adjusting the previous mapping relationship until completion of the forward traversing in accordance with the execution timing, thus obtaining a target forward mapping relationship; and
according to the target forward mapping relationship, backward traversing each of the logic gates in accordance with the execution timing and adjusting the physical bit mapped to each of the logic gates under the previous mapping relationship, and adjusting the previous mapping relationship until completion of the backward traversing in accordance with the execution timing, thus obtaining a target backward mapping relationship as the final mapping relationship.

2. The method of claim 1, wherein the constructing a to-be-mapped quantum program equivalent to the initial quantum program comprises:
constructing the to-be-mapped quantum program equivalent to the initial quantum program according to the final mapping relationship, to minimize a quantity of SWAP quantum logic gates in the to-be-mapped quantum program.

3. The method of claim 1, comprising:
obtaining a directed acyclic graph of the to-be-executed quantum program,
wherein the determining an execution timing of the logic gate set of the initial quantum program comprises: determining the execution timing of the logic gate set of the initial quantum program according to the directed acyclic graph of the to-be-executed quantum program;
wherein the obtaining a final mapping relationship further comprises: separately determining a cost of mapping each of the logic gates in the logic gate set to the topological structures of the physical bits in the quantum chip according to the execution timing and the initial mapping relationship,
wherein the constructing a to-be-mapped quantum program equivalent to the initial quantum program comprises:
adjusting the final mapping relationship of the to-be-executed quantum program according to the cost, to minimize the cost of the final mapping relationship.

4. The method of claim 1, comprising:
a first-rule logic gate set, wherein the first-rule logic gate set comprises: a single-bit quantum logic gate and a double-bit quantum logic gate with adjacent logic bits; and
a second-rule logic gate set, wherein the second-rule logic gate set comprises: a double-bit quantum logic gate with nonadjacent logic bits.

5. The method of claim 4, further comprising:
obtaining quantum circuits corresponding to the initial quantum program;
by traversing the quantum circuits, setting an execution timing of the first-rule logic gate set with a first timing of each qubit as a priority execution timing, and setting an execution timing of the second-rule logic gate set with a first timing of each qubit as a second-priority execution timing; and
deleting logic gates, if any, from the first-rule logic gate set and/or the second-rule logic gate set whose execution timing has been classified, and continuing to execute the setting an execution timing of the first-rule logic gate set with a first timing of each qubit as a priority execution timing, and setting an execution timing of the second-rule logic gate set with a first timing of each qubit as a second-priority execution timing until a classification of the execution timing of the logic gates of the quantum circuit has been accomplished.

6. (canceled)

7. The method of claim 1, wherein the constructing a to-be-mapped quantum program equivalent to the initial quantum program, comprises:
according to the final mapping relationship, inserting a SWAP quantum logic gate generated accordingly by operating each of the logic gates in accordance with the execution timing at a corresponding position in the quantum logic gate set, and determining a quantum program obtained after the inserting is completed as the to-be-mapped quantum program equivalent to the initial quantum program.

8. The method of claim 3, wherein the separately determining a cost of mapping each of the logic gates in the logic gate set to the topological structures of the physical bits in the quantum chip, comprises:
according to the execution timing and the initial mapping relationship, separately obtaining mapping schemes of mapping each of the logic gates to the topological structures of the physical bits in the quantum chip; and
constructing a cost formula for evaluating the mapping schemes and calculating cost of the mapping schemes.

9. The method of claim 8, wherein the adjusting a final mapping relationship of the to-be-executed quantum program, comprises:
according to the topological structures of the physical bits in the quantum chip and the initial mapping relationship, forward traversing and calculating a cost of mapping each of the logic gates to the topological structures of the physical bits in the quantum chip in accordance with the execution timing, and dynamically adjusting a mapping relationship of the to-be-executed quantum program until completion of forward traversing in accordance with the execution timing, thus obtaining a target forward mapping relationship;
according to the target forward mapping relationship, backward traversing and calculating a cost of mapping each of the logic gates to the topological structures of the physical bits in the quantum chip in accordance with the execution timing, and dynamically adjusting a mapping relationship of the to-be-executed quantum program until completion of backward traversing in accordance with the execution timing, thus obtaining a target backward mapping relationship; and
continuing forward and backward alternating iterative mapping, and repeating the dynamically adjusting a mapping relationship of the to-be-executed quantum program to minimize a cost of the final mapping relationship.

10. The method of claim 9, wherein the cost formula for evaluating the mapping schemes is:
$${F}_{cost} = {a}_{1} * \frac{1}{{T}_{2}} + {a}_{2} * {G}_{swap} + {a}_{3} * ( 1 - {f}_{double} ) + {a}_{4} * ( 1 - {f}_{measure} )$$
wherein T₂ is decoherence time of a quantum chip bit, G_{swap} is a quantity of swap logic gates required to be introduced for mapping all of the logic gates in the logic gate set to be mapped, f_{double} is fidelity of a double-bit quantum logic gate, fₘₑₐₛᵤᵣₑ is measuring fidelity, and a₁, a₂, a₃, a₄ are preset weight coefficients for the cost formula.

11. A mapping device for a quantum program and a quantum chip, comprising:
an obtaining module configured for obtaining topological structures of physical bits in a quantum chip, a logic gate set of an initial quantum program, and an initial mapping relationship between logic bits and the physical bits;
a determining module configured for determining an execution timing of the logic gate set of the initial quantum program;
an adjusting module configured for adjusting a mapping relationship between each of the logic bits corresponding to each logic gate of the logic gate set and one of the physical bits in accordance with the execution timing, according to the topological structures of the physical bits and the initial mapping relationship, thus obtaining a final mapping relationship; and
a constructing module configured for constructing a to-be-mapped quantum program equivalent to the initial quantum program according to the final mapping relationship, such that each of the logic gates in the logic gate set maps to the topological structures of the physical bits in the quantum chip at a lowest cost.

12. A storage medium, comprising a computer program stored therein, wherein the computer program is configured for executing a method of claim 1.

13. An electronic device comprising a memory and a processor, wherein the memory comprises a computer program stored therein, and the processor is configured for running the computer program to execute a method of claim 1.

14. A quantum computer operating system, wherein the quantum computer operating system is configured for constructing of a to-be-mapped quantum program according to a method of claim 1.

15. A quantum computer, comprising a quantum computer operating system of claim 14.
